(19) United States
(12) Patent Application Publication
(10) Pub. No.: US 2020/0232447 A1
(43) Pub. Date: Jul. 23, 2020

(54) SYSTEMS AND METHODS OF GENERATING SOLAR ENERGY AND DRY COOLING

(71) Applicant: Combined Power LLC, dba Hyperlight Energy, Lakeside, CA (US)

(72) Inventors: John D.H. King, La Jolla, CA (US); Gregory Mungas, Sun City West, AZ (US); Nicholas Aaron Kramer, San Diego, CA (US)

(21) Appl. No.: 16/487,856

(22) PCT Filed: Feb. 21, 2018
(86) PCT No.: PCT/US2018/018872

§ 371 Date: Aug. 22, 2019

Related U.S. Application Data
(60) Provisional application No. 62/462,375, filed on Feb. 23, 2017.

(51) Int. Cl. F03G 6/06; F24S 20/20; F24S 20/70; F24S 23/77; F24S 30/425; F24S 40/55

(52) U.S. Cl. CPC F03G 6/067; F24S 20/20; F24S 20/70; F24S 2025/02; F24S 30/425; F24S 40/55; F03G 6/06; F24S 23/77

(57) ABSTRACT

Dry cooling systems and methods are provided including at least one plastic elongated tube formed at least partially of a semi-rigid material and having a flat wall portion, a reflective material attached to said flat wall portion of the tube to reflect solar radiation, and at least one fluid channel in thermal communication with the reflective material, the fluid channel adapted to allow flow of a heat transfer fluid. Thermal power plants are provided which include a dry cooling system, one or more pipes in fluid communication with the dry cooling system, and at least one heat exchanger in fluid communication with the one or more pipes.

### CROSS-REFERENCE TO RELATED APPLICATIONS

This application claims priority to and benefit of International Patent Application No. PCT/US2018/018872, filed Feb. 21, 2018, which claims priority to and benefit of U.S. Patent Application Ser. No. 62/462,375, filed Feb. 23, 2017, each of which is hereby incorporated by reference in its entirety.

### FIELD OF THE DISCLOSURE

The present disclosure relates to dry cooling systems and methods and solar concentrating power plants.

### BACKGROUND OF THE DISCLOSURE

There has been a longstanding need to provide a means of energy efficient cooling of a utility-scale heat engine without using evaporation as the cooling mechanism. Though there are many different sources of energy in the world today, the overwhelming majority all boil water to extract work from a steam turbine. Coal, oil, solar thermal, geothermal, and biomass all generate power in this way. Natural gas power plants either use the gas to boil water for a steam turbine or else simply run the gas through a gas turbine. In either case, however, the exhaust from the turbine needs to be cooled to the lowest reasonably achievable temperature so as to maximize the turbine's efficiency.

The conventional method for cooling the exhaust from a turbine is to run it through a heat exchanger with liquid water at ambient conditions. This raises the temperature of the water, allowing it to carry energy away. There are two main modes of heat removal of power plant cooling water. Wet cooling and dry cooling. Wet cooling involves at one point or another, the evaporation of water, either with a cooling tower, in which water is sprayed on cooling fins, or with an evaporation pond, where water is allowed to evaporate from the surface of the pond. The majority of plants use some form of wet cooling if they can. This leads to significant water loss, which must be made up for with a significant amount of make-up water. This puts significant additional stress on water resources which are in many cases, already stressed. In some cases, the hot water is dumped to the ocean, and new, cold water is taken from the ocean. Increasingly, regulatory bodies are prohibiting this thermal pollution of the ocean, because of stress it puts on natural habitats. With dry cooling, the cooling water from a power plant can be pumped through a large heat exchanger that is cooled by large volumes of ambient air being blown by large, high power fans. While this method does not consume water, it does however consume large amounts of energy from the power plant itself. This dry cooling approach can represent a parasitic load on the plant of 10% to 15%, thus dramatically lowering its energy efficiency, which significantly impacts the economic performance of the plant.

In both traditional and renewable power plants, water usage is becoming an increasingly large barrier to permitting and construction of new power plants. This is a particularly severe problem for solar thermal power plants. Solar thermal plants require vast amounts of land and a large daily irradiance to maximize their return. They are therefore generally constructed in desert environments, where land is very inexpensive and the sun shines brightly for most of the year. These are the advantages of a desert environment, but there is an associated disadvantage. Deserts have very little water available, and what little exists is strictly monitored by local governments. Increasingly few municipalities are willing to allow power plants to consume vast amounts of water when farmers and other citizens need that water to survive. The resistance to evaporative cooling is causing many proposed power plants to switch to a dry cooling mechanism or to be cancelled entirely. There exists a need for energy efficient, dry cooling of a thermal power plant.

In addition to the need for energy efficient dry cooling, there has also been a long-standing need to provide energy generation from renewable sources. Various renewable energy sources have been pursued, such as solar energy, wind, geothermal, and biomass for biofuels as well as others.

Solar radiation has long been a prime candidate for fulfilling this need. In recent years, decreases in the cost of solar photovoltaic (PV) panels have led to proliferation of this technology at both small and large scale. The power produced by these panels is electrical and must be used when generated. The intermittency of this approach has brought about a new issue, the need for low cost energy storage to provide for grid stability and the ability of utilities to provide renewable power when it is needed, not only when the sun is up.

While electrical batteries are one candidate for energy storage they are still too high cost to be practical at large scale.

One approach to energy storage is unlocked by concentrated solar power (CSP) systems which typically use reflective surfaces to concentrate the sun's energy from a large surface area on to a solar collector. The concentrated solar energy can be used to heat a working fluid. The heated fluid is then used to power a turbine to generate electricity. Importantly, CSP converts solar energy to heat before it is converted to electricity. Heat can be stored in very low cost thermal storage media, such as molten salt, concrete, or even rocks. Such approaches are called Thermal Energy Storage (TES) systems. Many experts consider CSP+TES approaches to be fundamentally lower cost than PV+batteries.

Although CSP+TES systems are better than traditional PV+batteries, shortfalls exist. In particular, the water typically used to cool the CSP system is a roadblock to widespread deployment.

One approach (as taught in U.S. Pat. No. 8,443,615 B2) is to use the reflector elements of a CSP system themselves as an air cooled dry cooling assembly. Reflector elements formed of elongated tubes with a reflector mounted at or near the top can be used to advantage by flowing air through them as a cooling mechanism. This method still requires a high amount of air flow, and blower power.

It should be appreciated that there remains a need for a system and method of generating energy from solar radiation in a way that is cost effective with low cost storage, but that does not consume vast amounts of water. The present disclosure fulfills these needs and others.

### SUMMARY OF THE DISCLOSURE

In general terms, the present disclosure provides dry cooling systems and methods having various applications, including use for cooling the back end of a heat engine. Exemplary embodiments of a dry cooling mechanism comprise fluid channels of various geometries integrated with the mounting structures of CSP reflectors such as allow for continuous movement of the reflector to track the sun throughout the day. Such fluid channel will contain a dedicated section in thermal communication with a CSP reflector, through which cooling water in general, from a power plant, but possibly from any heat load, at elevated temperature is pumped, and heat is vented. Such fluid pumping and heat venting is a simultaneous use of the CSP system, that does not interfere with the proper function of the CSP reflector system, which is to aim and concentrate light.

Exemplary embodiments of a dry cooling system comprise at least one elongated tube formed at least partially of a semi-rigid material and having a flat wall portion, a reflective material attached to the flat wall portion of the tube to reflect solar radiation, and at least one fluid channel in thermal communication with the reflective material. The fluid channel is adapted to allow flow of a heat transfer fluid. In exemplary embodiments, the elongated tube is located in a support basin of water. In exemplary embodiments, the elongated tube further comprises a central air conduit. In exemplary embodiments, the semi-rigid material is plastic.

In exemplary embodiments, the elongated tube is incorporated into a heliostat assembly. The torsional load of the heliostat assembly may be 5 mRad or lower. In exemplary embodiments, the at least one elongated tube further comprises a slideable pipe next to the reflector. In exemplary embodiments, the heat transfer fluid comprises one or more of thermal oil, water, molten salt, or supercritical CO2. The system can be configured in a cooling track mode to cool the system.

Exemplary embodiments of a thermal power plant comprise a dry cooling system including at least one elongated tube formed at least partially of a semi-rigid material and having a flat wall portion, a reflective material attached to the flat wall portion of the tube to reflect solar radiation, and at least one fluid channel in thermal communication with the reflective material. The fluid channel is adapted to allow flow of a heat transfer fluid. The thermal power plant further comprises one or more pipes in fluid communication with the dry cooling system and at least one heat exchanger in fluid communication with the one or more pipes. Water is routed through the at least one heat exchanger to the dry cooling system. The water is circulated in thermal communication with the reflective material, and the water is heated. In exemplary embodiments, the water gives up heat, the reflective material radiatively dumps the heat from the water, and the water is recirculated through the heat exchanger. In exemplary embodiments, the at least one elongated tube is located in a support basin of water.

Exemplary methods of dry cooling comprise routing water through a heat exchanger, routing the water through one or more pipes to a dry cooling system including one or more solar reflectors, circulating the water in thermal communication with a reflective material of the one or more solar collectors such that the water is heated, circulating the heated water such that the heated water gives up heat and the reflective material radiatively dumps the heat from the water, and circulating the water such that the water is rerouted through the heat exchanger.

In the system and method as taught in U.S. Pat. No. 8,443,615 B2, which is hereby incorporated by reference herein in its entirety, the cooling mechanism is water to air heat transfer through conduction. Despite the fact that nearly all dry-cooling approaches used in power plant and process heat applications involve conduction to air at some point, a surprising feature of moving cooling water through a conduit in close proximity to a CSP reflector surface is that if one achieves direct thermal communication between the reflector and the water, the rate of heat loss due to IR radiation is significantly higher than that achieved through water to air conductive heat transfer in the same configuration. This has the counter-intuitive result that it is more advantageous from a cooling standpoint to fully fill the tubes with water (or other heat transfer fluid) to bring it into direct thermal communication with the reflector surface, than to blow air through the tubes when they are half full (including solar spectrum, and Earth IR spectrum, and absorption spectrum of glass).

At the component level, this is a surprising result to be sure. However, at the system level, it is perhaps even more surprising. The range of temperatures available to a power plant is typically less than 100° C. because the main purpose of a power plant cooling system is to condense steam into liquid water. This provides an upper limit of operational temperature difference (delta T) for the presently disclosed invention of 100° C. minus ambient, which in some cases can be as high as 45° C. and in other cases can be below 0° C. Importantly, the average daily rate at which a CSP reflector can vent heat through radiation is actually higher than the amount of daily heat input to that same reflector through solar flux alone. This means that if the delta T is between 0° C. and 100° C. that a CSP reflector field can be used to vent heat from a power plant using the CSP heat as its sole input or as only part of the input. That is to say, hybridizing an existing thermal plant with the present invention, would boost the dry cooling capability of the plant over-all. For example, if the CSP field were installed to boost the heat input to a geothermal power plant, in a hybrid configuration or a natural gas fired power plant in a hybrid configuration, there are two distinct advantages to the plant being hybridized. First, the proper functioning of the CSP reflector array itself allows for renewable energy to be added to the plant and boost its output. Second, the heat venting capability of the field, when configured according to the present invention also reduces either the blower power needed to vent the previously existing heat load, or reduces the consumptive water use to vent the previously existing heat load.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a schematic of an exemplary embodiment of a hybrid geothermal and concentrated solar power plant in accordance with the present disclosure;

FIG. 2 is a schematic of an exemplary embodiment of a hybrid geothermal and concentrated solar power plant in accordance with the present disclosure;

FIG. 3 is a process flow diagram of an exemplary method of dry cooling in accordance with the present disclosure;

FIG. 4 is a perspective view of an exemplary embodiment of dry cooling system in accordance with the present disclosure;

FIG. 5 is a schematic of an exemplary embodiment of a thermal power plant in accordance with the present disclosure; and

FIG. 6 is a cross-sectional view of an exemplary embodiment of an elongated tube in accordance with the present disclosure.

### DETAILED DESCRIPTION

In the following detailed description of exemplary embodiments of the disclosure, reference is made to the accompanying drawings in which like references indicate similar elements, and in which is shown by way of illustration specific embodiments in which disclosed systems and devices may be practiced. These embodiments are described in sufficient detail to enable those skilled in the art to practice the embodiments, and it is to be understood that other embodiments may be utilized and that logical, mechanical, functional, and other changes may be made without departing from the scope of the present disclosure. The following detailed description is, therefore, not to be taken in a limiting sense, and the scope of the present disclosure is defined by the appended claims. As used in the present disclosure, the term “or” shall be understood to be defined as a logical disjunction and shall not indicate an exclusive disjunction.

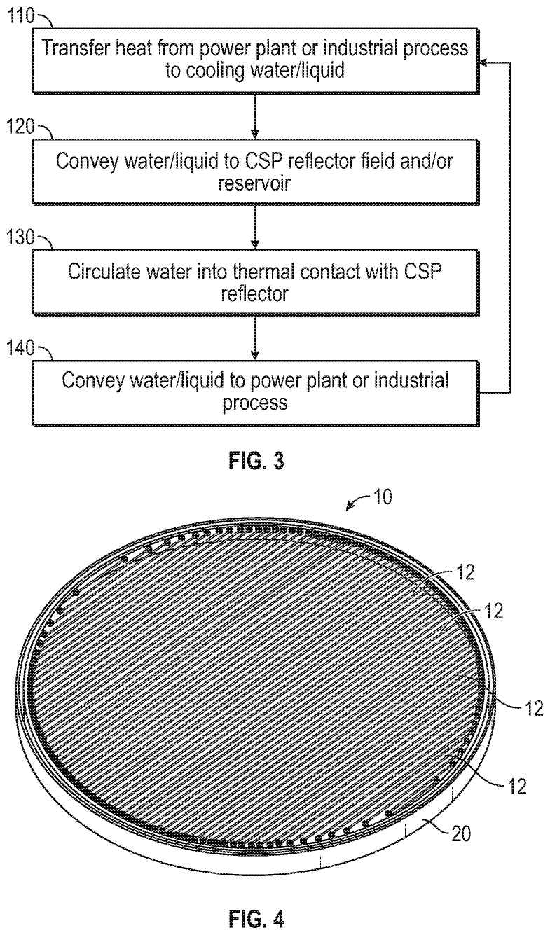

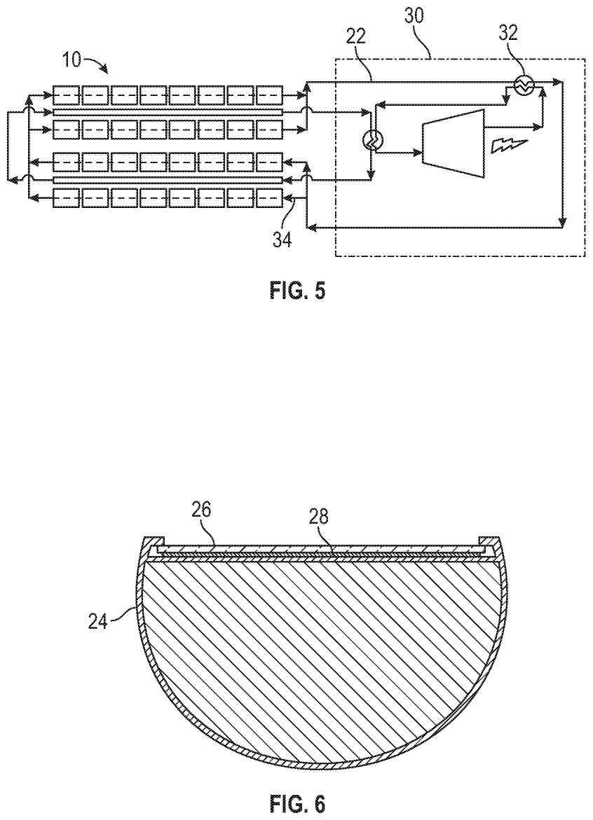

Exemplary embodiments of the presently disclosed invention include a thermal power plant 30, illustrated in FIG. 5 and associated dry cooling methods, shown in FIG. 3, wherein heat from the power plant is transferred to the the cooling water 22 (or other heat transfer fluid) (step 110)), which is routed through a heat exchanger 32 to provide cooling to the power plant 30. Then the cooling water 22 is routed through one or more pipes 34 to a CSP reflector field (step 120), said collector field configured to provide a heat boost to the thermal power plant and also to allow for circulation of water in direct thermal communication with one or more of the reflector elements of the CSP array (step 130). This heated water which is routed into direct thermal communication with one or more CSP reflectors gives up heat which is radiatively dumped by the reflector and the water returned to ambient or close to ambient. At that point the water is recirculated to the power plant (step 140) to perform its cooling function once again and the cycle is repeated, with no net loss of water through evaporation. This process is illustrated by the flow diagram in FIG. 5.

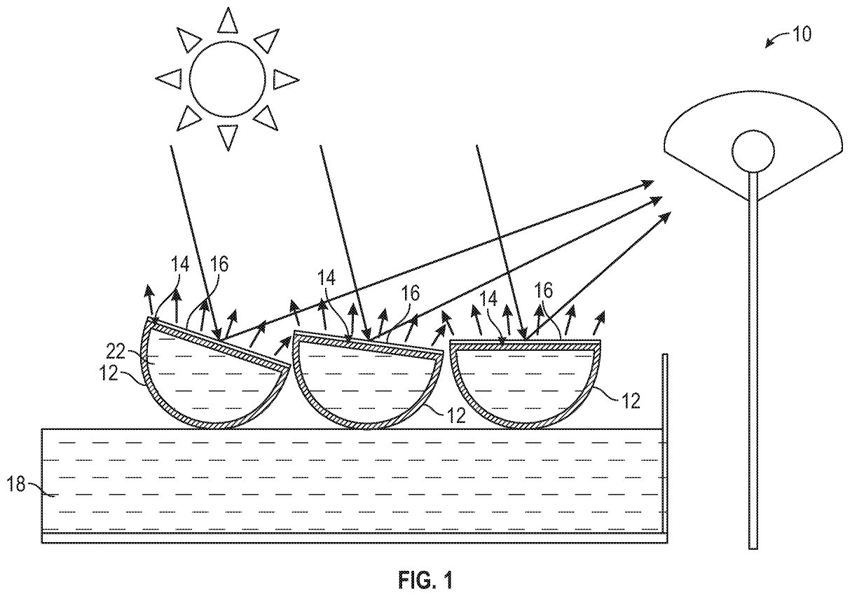

Referring to FIG. 1, exemplary embodiments of a dry cooling system 10 comprise an elongated tube 12, made at least partially of a flexible or semi-rigid material such as plastic, with a flat wall portion 14, which is a section built into a wall of the tube or attached to the wall of the tube, and a reflective material 16 attached to the flat wall portion 14 of the tube 12 to reflect solar radiation. The elongated tube 12 may have an axis of rotation oriented generally parallel to a surface of a supporting body of liquid 18. The elongated tube may be elastically or plastically deformed by application of a torque along its length, so as to bring flat-surface normal vectors at each end of the tube largely into alignment with each other. The dry cooling system 10 may further comprise one or more individual sections that are coupled together through either rigid or flexible couplings, mid-span. Liquid ballast may or may not be used in various embodiments of this invention. In exemplary embodiments, the inner portion of the tube defines a reservoir containing fluid facilitating ballast, the fluid having a top surface generally parallel to the surface of a support body of liquid.

In the case of a floating tube structure mounting system for a CSP reflector, to move too high of a volume of water (or other heat transfer fluid 22) into thermal communication with the reflector section, the tube would lose buoyancy and sink into the water support. Moreover, the increased mass within the tube itself would lead to asymmetric loading on the mechanical system, and cause mis-aiming of the reflector element itself.

CSP reflectors are typically glass mirrors, but they can also be other types of reflectors, for example, polymer reflectors. Importantly, most reflectors (both glass mirror and polymer reflectors) possess certain inherent qualities that can be exploited for use in the present invention. Reflectors by their nature are typically composed of a volume of material that is largely transparent in the solar spectrum, with a layer at the bottom that is reflective in the solar spectrum. This means that the reflector will not absorb the majority of solar radiation impingent on it. However, if one looks at the black-body radiation spectrum of the earth, the glass, or other visibly transparent material of most reflectors is opaque and will emit non-negligible amounts of energy in the IR spectrum.

In exemplary embodiments, heat can be transferred from the cooling water to the mirror through conduction, convection, or radiation, and the primary mode of ultimate heat rejection is when the heat is vented through radiation from the reflector. This effect can work throughout the day and night.

Importantly, to achieve this end, it is critical that the function of the mirror in its use as a solar concentrator not be compromised. For this reason, the temperature gradient of the fluid within the tube must be managed so as not to cause bending or warping of the mirror which would interfere with its function as a CSP reflector. Further, in order not to interfere with the reflector's primary function of reflecting light onto a target, no additional materials or assemblies can be introduced in front of the reflector, the reflector must remain exposed to ambient air.

In the case of a line focus reflector system, such as a Linear Reflector System (LFR) or parabolic trough system, the reflector system will have actuators at periodic distances along their length, with spacing at intervals between the actuators. Between these actuators, the reflector systems experience torsion. Adding a volume of water to the reflector system, whether it be in a plastic tube, or as a water jacket of some form, mounted on a scaffold consisting of traditional steel and concrete construction, will change the torsion characteristics of the reflector system. There exists an upper limit of practical application of this additional torsional load. As a general rule, a torsion of more than 5 mRad is not acceptable without adversely affecting the performance of the reflector system. Accordingly, embodiments of this invention are generally characterized as configurations where the net torque T, of the water conduit system on the linear reflector system is less than or equal to 0.005*G*J_{T}/1. Where G is the modulus of rigidity of the reflector mounting system, J_{T} is the torsional constant for the cross section of the reflector mounting system, and 1 is one half the distance between the most closely spaced actuators of the reflector mounting system.

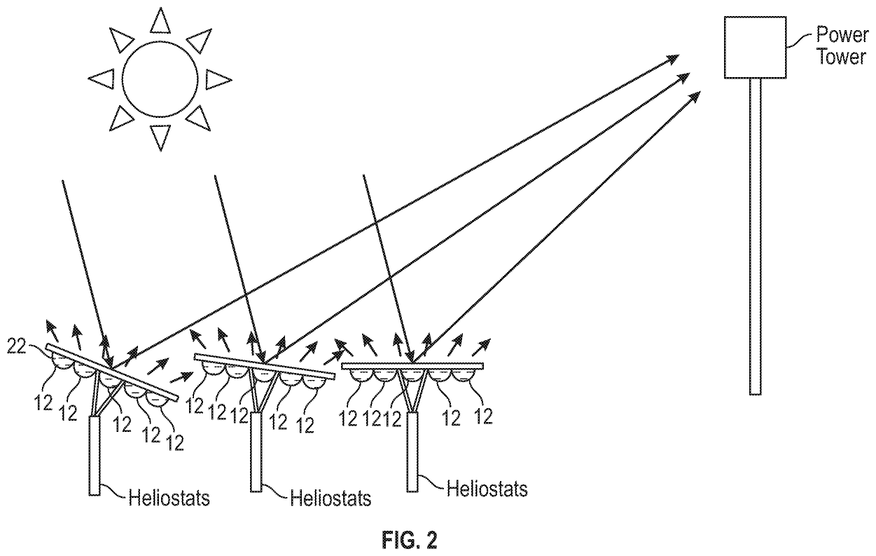

Turning to FIG. 2, in the case of point focus reflectors, such as heliostats for a power tower configuration, the bending moment is a closer descriptor and limiter of practical application. The 5 mRad rule of thumb is equally applicable, so accordingly, embodiments of the present invention are generally characterized as configurations in which the volume and distribution of water routed through a reflector system impart a net load on a reflector system less than or equal to 0.005*6*E*I/L³. Where E is the modulus of elasticity of the reflector mounting structure, I is the area moment of inertia of the reflector mounting system, and L is the distance from the nearest actuator to the end of the reflector.

The functional relationships described above are for idealized beam configurations, but it should be noted that even in the case of more complicated designs that reduce the volume of materials used in construction and require more detailed analytical approaches, the basic nature of the invention remains: specifically that the net imparted torsion or torque on the CSP reflector system cannot cause the reflector system to be affected by more than 5 mRad—or else it ceases to serve as both an effective CSP reflector and a heat radiator.

Whatever conduit may be used to move the water behind the reflector system, it will undergo temperature cycling as hot water is moved into it, then cooled and moved out. This will lead to thermal cycling and associated thermal expansion and contraction. Importantly, this thermal expansion and contraction cannot be allowed to bend, break, or warp the glass. One approach is to use a flexible material for the conduit, another is to allow thermal coupling of the conduit to the reflector, but to prevent mechanical coupling. As illustrated in FIG. 6, this can be achieved by placing a pipe 24 next to the reflector 26 but allowing the pipe to slide next to the reflector when it changes dimension due to temperature cycling or for any reason. At the interface, the use of a heat conducting paste 28, or gel or other similar substance can be used to ensure good heat transfer between the conduit and the reflector.

Also, it is possible to limit the temperature gradient to a certain maximum amount, In practical terms, a maximum delta T of 75° C. is sufficient to ensure that less than 5 mRad of angular inaccuracy is imparted, in both the case of plastic and metal supports.

As shown in FIG. 4, large basins or reservoirs 20 can be configured and used to store hot water during the day and use the cooling capability of the reflectors at night. Embodiments of the present disclosure include a support basin 20 for supporting elongated tubes with reflectors mounted on them. This support basin 20 can be covered as a water bed, or partially open. In both cases, it can be configured so that water is circulated from the basin into the pipes to cool the water. In this way, each basin can be used as a water reservoir. This effectively stores cooling capacity for the system.

In general, CSP reflectors have a “stow” mode for high winds and other reasons. The water conduit system consistent with this invention does not interfere with the function of the reflector being put into stow mode, remaining in stow mode, or coming out of stow mode. Alternatively, the performance of the radiant cooling will be best, when the reflector is pointed at the portion of the sky with the least incoming IR radiation, so a “cooling track” mode can be substituted for “stow mode” or any other mode wherein the tracking of the sun is not immediately needed. The cooling track mode can be used to maximize cooling by using one or more sensors to determine the optimal direction to point for maximum cooling.

In the case of tubes configured to float on water to mount reflectors, filling the inner chamber completely would cause these tubes to be submerged and not function. So the present disclosure includes additional internal geometry (such as a central conduit containing air which does not interfere with the thermal communication of the hot water with the reflector) to facilitate floatation and/or a bottom sheet on top of the body of supporting water, on top of which, all the tubes sit, which that facilitates floatation from outside to tubes themselves.

While the apparatus, systems, and methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation to encompass all such modifications and similar structures. The present disclosure includes any and all embodiments of the following claims.

Thus, it is seen that dry cooling systems and methods and solar concentrating power plants are provided. It should be understood that any of the foregoing configurations and specialized components or chemical compounds may be interchangeably used with any of the systems of the preceding embodiments. Although illustrative embodiments are described hereinabove, it will be evident to one skilled in the art that various changes and modifications may be made therein without departing from the disclosure. It is intended in the appended claims to cover all such changes and modifications that fall within the true spirit and scope of the disclosure.

What is claimed is:

1. A dry cooling system comprising:
at least one elongated tube formed at least partially of a semi-rigid material and having a flat wall portion;
a reflective material attached to said flat wall portion of the tube to reflect solar radiation;
at least one fluid channel in thermal communication with the reflective material, the fluid channel adapted to allow flow of a heat transfer fluid.

2. The system of claim 1 wherein the at least one elongated tube is located in a support basin of water.

3. The system of claim 2 wherein the at least one elongated tube further comprises a central air conduit.

4. The system of claim 1 wherein the at least one elongated tube is incorporated into a heliostat assembly.

5. The system of claim 1 wherein the torsional load of the heliostat assembly is 5 mRad or lower.

6. The system of claim 1 wherein the at least one elongated tube further comprises a slideable pipe next to the reflector.

7. The system of claim 1 wherein the heat transfer fluid comprises one or more of thermal oil, water, molten salt, or supercritical CO2.

8. The system of claim 1 wherein the at least one elongated tube can be configured in a cooling track mode to cool the system.

9. The system of claim 1 wherein the semi-rigid material is plastic.

10. A thermal power plant comprising:
a dry cooling system including at least one elongated tube formed at least partially of a semi-rigid material and having a flat wall portion, a reflective material attached to said flat wall portion of the tube to reflect solar radiation, and at least one fluid channel in thermal communication with the reflective material, the fluid channel adapted to allow flow of a heat transfer fluid;
one or more pipes in fluid communication with the dry cooling system; and
at least one heat exchanger in fluid communication with the one or more pipes;
wherein water is routed through the at least one heat exchanger to the dry cooling system, the water is circulated in thermal communication with the reflective material, and the water is heated.

11. The power plant of claim 10 wherein the water gives up heat, the reflective material radiatively dumps the heat from the water, and the water is recirculated through the heat exchanger.

12. The power plant of claim 10 of claim 1 wherein the at least one elongated tube is located in a support basin of water.

13. A method of dry cooling, comprising:
routing water through a heat exchanger;
routing the water through one or more pipes to a dry cooling system including one or more solar reflectors;
circulating the water in thermal communication with a reflective material of the one or more solar collectors such that the water is heated;
circulating the heated water such that the heated water gives up heat and the reflective material radiatively dumps the heat from the water; and
circulating the water such that the water is rerouted through the heat exchanger.
